(19) United States
(12) Patent Application Publication
(10) Pub. No.: US 2012/0068670 A1
(43) Pub. Date: Mar. 22, 2012

(54) WIND JET TURBINE

(76) Inventor: Shamel A. Bersiek, Laguna Hills, CA (US)

(21) Appl. No.: 13/257,141

(22) PCT Filed: Mar. 16, 2010
(86) PCT No.: PCT/US10/27531

§ 371 Date: Nov. 28, 2011

Related U.S. Application Data
(60) Provisional application No. 61/210,215, filed on Mar. 16, 2009.
(60) Provisional application No. 61/173,889, filed on Apr. 29, 2009.

(51) Int. Cl. H02P 9/48; F03D 9/00

(52) U.S. Cl. 322/30; 290/55

(57) ABSTRACT

A wind jet turbine with a housing that creates an air density deferential between the air within the housing and the wind passing outside the housing in order to generate the same or more electrical power in less space than traditional wind turbines.

### CROSS-REFERENCE TO RELATED APPLICATIONS

This application claims priority to U.S. Provisional Patent Application, Ser. No. 61/210,215, titled WIND JET TURBINE, filed on Mar. 16, 2009, and U.S. Provisional Patent Application, Ser. No. 61/173,889, titled WIND JET TURBINE II, filed on Apr. 29, 2009, all of which are incorporated herein by reference.

### BACKGROUND OF THE INVENTION

1. Field of the Invention

The present invention generally relates to a power generation device/generator and more specifically relates to power generating devices with rotational blades.

2. Related Art

Wind turbines are traditionally designed to capture the wind via rotating blades that turn a generator unit located at the center or hub of the blades. The power produced by this type of generator is proportional to the wind velocity, swept area, and air density (Power=0.5×Swept Area×Air Density×Velocity³). Unfortunately, traditional wind turbines are expensive, inefficient and occupy a considerable amount of space. Traditionally, wind power devices have utilized many different technologies for blades, gearboxes, and electrical generators, but still produce limited amount of power due to the fact that all the designs are basically similar and follow the same generator principles, namely traditional three bladed propeller windmill designs.

Several companies make three bladed propeller windmills or wind turbines. The three bladed wind turbines are designed to capture the wind via the three rotating blades that turn a generator unit located in the center of the blades. Thus, the three blade wind turbines produce electrical power by rotational torque that is created by the surface area of the blades. The most effective part of the blades is the portion that travels through the greatest volume of air. That part is found at the tips of the blades. Unfortunately the three-bladed turbine blade tips surface area calculates to be less than 10% of the total surface area.

It would be useful to produce power using rotating blades in a small footprint while increasing the effective part of the blades in order to produce two to five times the power as traditional devices while occupying the same space as the traditional three bladed wind turbines.

### SUMMARY

The present blade design is unique with the total area of the blades being located on the outside 50% of the assembly while eliminating the inner 50%, thus reducing the total weight of the blades. By eliminating the inner 50% of the blades, this invention introduces a “ported” aerodynamic system which allows the inner 50% of the wind to pass though the first blades of the wind jet turbine without interruption and the outer 50% to be angularly redirected. The blade shape creates a Venturi effect that causes the wind speed to increase while passing through the ported center section of the wind jet turbine. The combination of the increased inner wind speed and the redirected outer wind speed of the air leaving the turbine may result in an unchanged wind speed at the tail end of the wind jet turbine. Betz law was created in 1919 and published in 1926 and is used to calculate the power output of a wind turbine by the differential wind speed entering and leaving the wind turbine or blades. Betz law defines 0.59% as being the limit of the amount of power that may be derived from an air mass passing through the swept diameter of a rotor or blade.

Thus, an increase in power production is achieved when the wind speed is significantly unchanged between entering and leaving the wind jet turbine. Additionally, the wind jet turbine eliminates the aerodynamic bubble that typically forms over the wind turbines. This approach also eliminates Betz law from applying to the entire wind jet turbine. Rather Betz law only applies to each blade individually in the wind jet turbine.

The wind jet turbine may be designed with blades contained within a housing that maximizes wind capturing and effective striking area. The electric generator may be designed to reduce losses and increase efficiency. The power generation in the generator section may be based on a new principle for generating power in a rotating machine. The principals utilizes magnets in combination with duration and electric cancellation all combined in one system to generate electrical power. The new approach may be called Magnetic Width Modulation (MWM). The MWM principle may be applied to motors, generators or any machine where magnetic variation is employed.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 shows a perspective and diagrammatical view of an embodiment of the wind jet turbine in accordance with an example implementation of the present invention.

FIG. 2 shows a perspective and diagrammatical view of multiple embodiments of the wind jet turbine of FIG. 1 on a single structure or pole in accordance with an example implementation of the present invention.

FIG. 3 shows a perspective and diagrammatical view of an embodiment of the rotating blades of the wind jet turbine of FIG. 1 in accordance with an example implementation of the present invention.

FIG. 4 shows a perspective and diagrammatical view of an embodiment of the main blade biased by a spring in the wind jet turbine of FIG. 1 in accordance with an example implementation of the present invention.

FIG. 5 shows a perspective and diagrammatical view of an embodiment of the magnet at the end of each rotating blade in the wind jet turbine of FIG. 1 in accordance with an example implementation of the present invention.

FIG. 6 shows a perspective and diagrammatical view of an embodiment of the permanent magnet and spring at the end of each rotating blade of wind jet turbine of FIG. 1 in accordance with an example implementation of the present invention.

FIG. 7 shows a diagrammatical view representation of the main generator power core and windings of wind jet turbine in accordance with an example implementation of the present invention.

FIG. 8 shows a diagrammatical view representation of the wave form of a variable width magnet signal generated by the wind jet turbine of FIG. 1 in accordance with an example implementation of the present invention.

FIG. 9 shows a diagrammatical view representation of the main generator power core and windings for generating Direct Current (DC) power from the wind jet turbine of FIG. 1 in accordance with an example implementation of the present invention.

FIG. 10 shows a diagrammatical view representation of the main generator power core and windings example of the generating Alternating Current (AC) from the wind jet turbine of FIG. 1 shows accordance with another example implementation of the present invention.

FIG. 11 shows a block diagram of the control circuit for sensing, reporting and controlling the transistor firing for the induced magnet coils in accordance with an example implementation of the present invention.

FIG. 12 shows a diagram depicting a “U” shaped rotor and the stator coils together in an assembly in accordance with an example implementation of the present invention.

FIG. 13 shows a flow diagram of the generation of current by the wind jet turbine of FIG. 1 in accordance with an example implementation of the present invention.

### DETAILED DESCRIPTION

Unlike the known approaches previously discussed, a wind jet turbine as disclosed herein overcomes the above limitations. For example, one of the implementation of this wind jet turbine may be a wind turbine in a wind farm. The physical size for the grid application wind jet turbine may be from a few feet to hundreds of feet. Another example application of a wind jet turbine may be for residential use to generate power for building in the range of 1-2 Kilowatt to a few Megawatts. The physical size of residential and commercial wind jet turbines may be from a foot to several feet (such as 20 feet).

Another application of a wind jet turbine may be generating power for vehicles, boats, planes and/or any moving vehicle with the generated power in the Kilowatt range. The physical size of a vehicle wind jet turbine would be from a few inches to a few feet. Furthermore, the approach for generating power with the wind jet turbine is not limited to wind, but may be employed with any current or mass (i.e., fluid—where fluid includes wind) that can produce force to rotate the blades, such as water. The wind jet turbine may also be used to produce power for emergencies, such as backup power for a building.

The housing and blade design may generate power by rotating a standard power generator, for example, with a rotor and stator such as in a conventional diesel generator or may generate power by utilizing Magnetic Width Modulation (MWM) or direct current (DC) generation approaches.

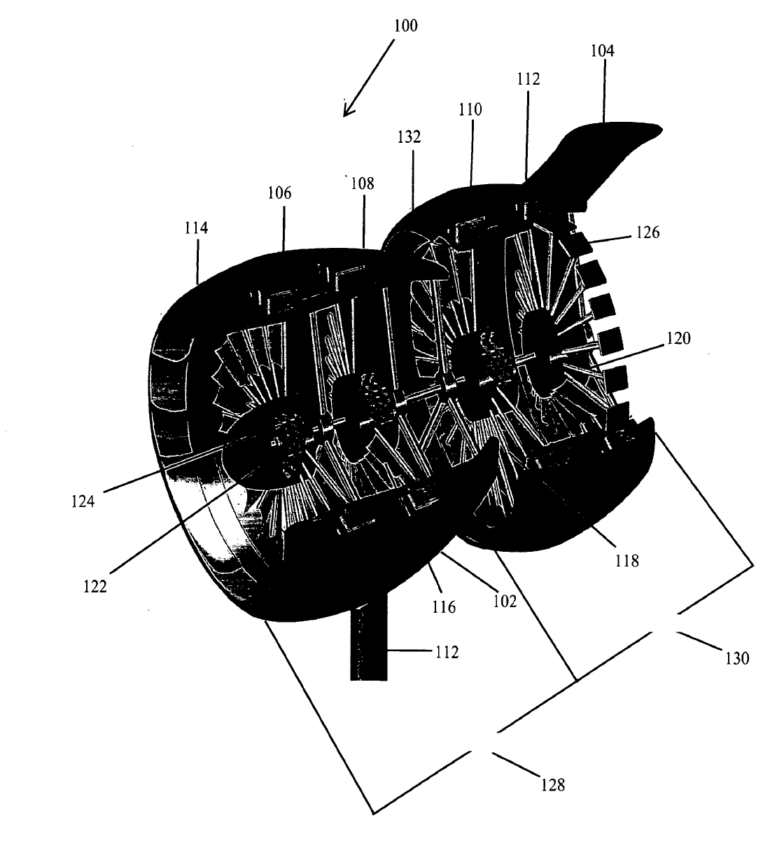

Turning to FIG. 1, a perspective and diagrammatical cut view of an embodiment of a wind jet generator 100 in accordance with an example implementation of the present invention is shown. The wind jet generator 100 may have a housing 102 and one or more metal winding 106, 108, 110, and 112 integrated in the housing 102. In other implementations, the metal windings 106, 108, 110 and 112 may be located within the housing 102 or upon the housing 102. The housing 102 may also have a fin 104 that aids in turning the wind jet generator 100 into the wind. The housing 102 or other mounting area may be rotatably mounted to a pole 112 or other support structure.

One or more sets of blades, such as stage one blades 114, stage two blades 116, stage three blades 118, and stage four blades 120, may be rotatably secured within the housing. The sets of blades may be secured to a single shaft as shown in FIG. 1 or individually to smaller shafts in other implementations. The sets of blades, such as 114, 116, 118, and 120, may each be secured to a respective hub (i.e., set of blades 114 secured to hub122) that may also rotate around an inner set of metal windings 124. Each blade in a set of blades may have an outer blade tip area 126 that may be magnetic or electro-magnetic. The blades may have fan portions that do not fully extend from the hub to the blade tips as in the present example implementation, or in other implementations the fan blades may extend fully from the hub to the blade tips.

Maximum power relative to the amount of wind velocity occupying a relatively small area compared to traditional three blade wind turbines is achieved with the wind jet turbine 100. The housing 102 of the wind jet turbine 100 may be divided into two sections, section A 128 and section B 130. In other implementations, the housing may be made of only one section or more than two sections. Section A 128 of housing 102 captures the wind and directs it to the stage one blades 114 and stage two blades 116. In some implementations, the stage one blades 114 may rotate in a direction opposite of the stage two blades 116. Section B 130 captures the wind coming through section A 128 in combination with outside wind directed through an opening132 formed between sections A 128 and B 130.

Section B 130 captures the wind and directs it to the stage three blades 118 and stage four blades 120. In some implementations, stage three blades 118 may rotate in the same direction as stage one blades 114 and stage four blades 120 may rotate in the same direction as stage two blades 116. The wind striking the areas of the blades in combination with the counter rotating blades increases wind capturing while increasing the stability within the wind jet turbine.

The shape of the housing 102 increases the wind speed and increases the air density inside the wind jet turbine while creating a density deferential between the air within the housing 102 and the outside passing wind. The air density increases the power of the wind inside of the housing when striking the blades in accordance to the formula (Power=0.5×Swept Area×Air Density×Velocity³).

The interior section of the housing 102 may be configured or formed to capture the wind through a large opening area 132 and direct the wind through the interior of a decreased diameter area (see B 130 of FIG. 1). The decreasing diameter and area of the interior section results in wind speed and wind density being increased which translates into increased power.

The housing 102 of FIG. 1 increase the distance of travel of the wind around the exterior of the housing 102 and creates the wind speed differential between the interior and the exterior of the wind jet turbine. This differential creates or results in a vacuum at the tail end of the housing 102 and increases the speed of the wind traveling through the interior section. The increased pressure and wind speed in the interior of the housing 102 compared to the lower pressure on the exterior of the housing 102 results in more stability of the total structure of the wind jet turbine.

The blade tip surface area 126 may be increased, for example, 20 to 1000 times, compared to traditional wind turbines of similar size. This increase of the outer blade tip surface area goes through a tremendous volume of wind and creates extremely high torque. The blade design of FIG. 1 is unique as the total area of the blades is located on the outside 50% of the blades assembly eliminating the inner 50%, thus reducing the total weight of the blades. By eliminating the inner 50% of the blades the current approach introduces a ported aerodynamic system that allows the inner 50% of the wind entering the housing 102 to pass though the wind jet turbine without interruption and the outer 50% to be angularly redirected.

The blade design creates a Venturi effect that causes the wind speed to increase while passing through the ported center section of the housing 102 of the wind jet turbine 100. The combination of the increased inner wind speed and the redirected outer wind speed leaving the turbine results in an unchanged wind speed at the tail end (end with tail 104) of the wind jet turbine.

Betz law was published in 1926 and defined 0.59% as being the limit of the amount of power that may be derived from an air mass passing through a swept diameter of a rotor. Betz law calculates the power output of a traditional wind turbine by the differential wind speed entering and leaving the turbine or blades. The wind jet turbine approach thus results in tremendous power production with a relatively unchanged wind speed entering and leaving. In addition, the current wind jet turbine approach eliminates the aerodynamic bubble that typically forms over wind turbines by having the wind speed entering and leaving the wind jet turbine approximately equal. The wind jet turbine approach also eliminates Betz law from applying to the entire wind jet turbine. Rather, Betz law applies only to each blade of the wind jet turbine individually.

With Betz law applying to each blade of the wind jet turbine individually instead of relating to the overall turbine and blade diameter, advancement in technology of wind turbine design is achieved. By using the standard formula Lf×Wp=Fp (Leverage feet×Wing pounds=Food pounds), multiplying the foot pounds of torque times the number of wings in turbine to find the total power of the wind turbine resulting in a total power formula of:

Total power=(Lf×Wp)×number of wings.

By having high number of aerodynamic blade tips at the farthest distance from the center of rotation (blade tips 126), the wind jet turbine 100 is able to convert wind energy exerted on individual wings in the sets of blades (114, 116, 118, 120) into high torque leverage resulting in higher power output than traditional wind turbines of similar size.

The wind jet turbine blades of a large wind jet turbine n accordance withy the present invention weigh only in hundreds pounds each compared to the traditional large three-bladed turbines that weigh thousands of pounds each. The present invention introduces lighter weight blades and structure that can rotate at higher RPM, for example, three to four times the RPM of traditional wind turbines without affecting the stability of the total assembly. This added stability at high RPMs eliminates the need for a transmission/gearbox and at the same time takes advantage of the RPM increase to produce additional power. Furthermore, the lighter blades may be made lighter with the use of light weight materials, such as aluminum or plastic.

For example, if a traditional wind turbine has a 25 foot radius and captures 100 pounds of force per blade at a 20 mph wind speed, then the total torque is:

25 Lf×100×3 Wp=7,500 f.lb.

In the present wind jet turbine approach, with a 25 feet radius (housing 102 front opening), 21 blades and 100 pound of force at a 20 mph wind speed the torque is;

25 Lf×100×21 Wp=52,500 f.lb.

By using the formula:

Power (kW)=(Torque×2×3.14×Rpm)/60000,

the present approach introduces a high torque wind jet turbine that is small in diameter and high in RPM. The wind jet turbine produces seven times the torque and three to four times the RPM and results in 21-28 times more power than traditional wind turbines of similar size.

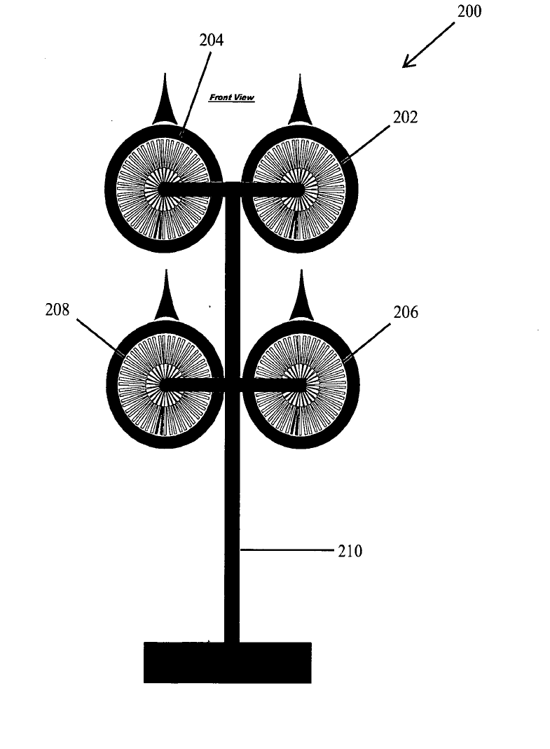

In FIG. 2, a perspective and diagrammatical view of an embodiment 200 with multiple wind jet turbines 202, 204, 206, and 208 coupled to a single structure or pole 210 in accordance with an example implementation of the present invention is shown. The counter rotating blades increase the stability of the wind jet turbines 202, 204, 206, and 208, allowing for grouping them in close proximity to each other and sharing a support structure, such as pole 210. A greater number of wind jet turbines may also be placed in the same space foot print as a single traditional wind turbine. Each of the wind jet turbines 202, 204, 206, and 208 may have a tail that aids in keeping the wind jet turbines 202, 204, 206, and 208 facing into the wind. In other implementations, one or more fins may be located on the support structure rather than on the wind jet turbines.

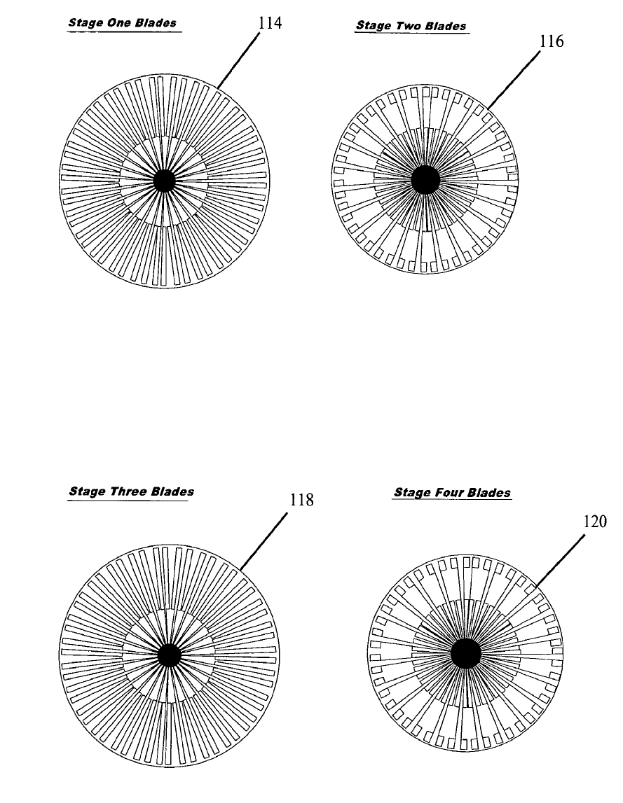

Turning to FIG. 3, a perspective and diagrammatical view of an embodiment of the rotating blades of the wind jet turbine in accordance with an example implementation of the present invention is shown. The blades of the wind jet turbine are designed to adapt to any wind speeds from one mph to 250 mph. Three types of aerodynamic principles are employed by the wind jet turbine: (1) compression with the wing blades design, (2) vacuum with the outside aerodynamic body design; and (3) angle of attack with the variable blade pitch angle. Stage one blades 114 may be similar to stage three blades 118, but with the blades going in opposite directions. Stage two blades may be similar to stage four blades but with the blades also going in opposite directions.

The wind jet turbine 100 enhances the efficiency of the blades by utilizing multiple blades, for example, from 20 to 1000 blades. The multiple blades and reduced inner blade area increases the effectiveness of the wind striking areas of all blades in all stages, for example, by eliminating the inside 50% of the blades in all stages (114, 116, 118, and 120) or eliminating the inside 50% of stage one blades 114 and stage three blades 118 and the middle to outside 50% of stage two blades 116 and stage four blades 120. This allows significant air to pass through the center of and the sides of the blades so an aerodynamic bubble does not form over the wind jet turbine 100 and eliminates Betz law from applying to the entire wind jet turbine. Each blade of the wind jet turbine in the current example has a 0.59% Betz limit.

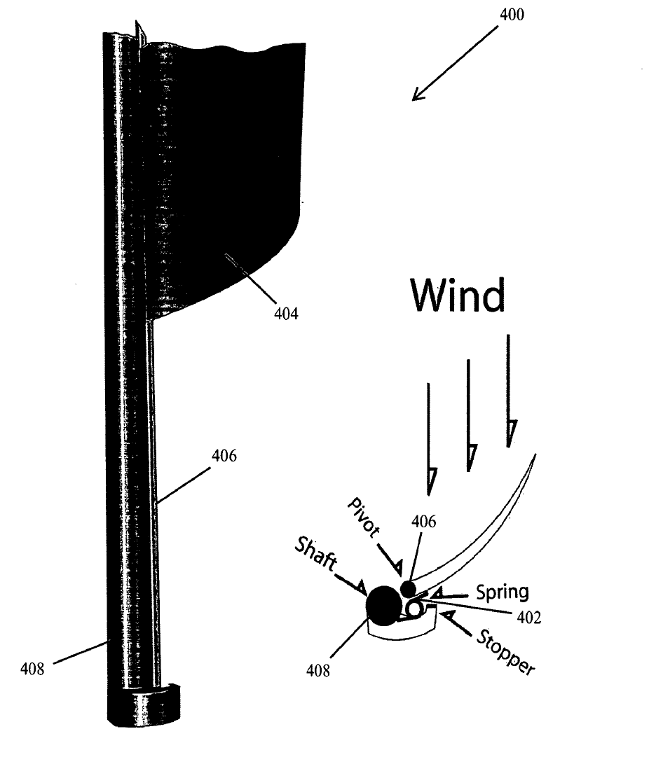

In FIG. 4, a perspective and diagrammatical view of an embodiment of a blade 400 and spring 402 assembly for the example wind jet turbine 100 is shown. Each of the blades in a set of blades may be designed with two sections; both sections may be concaved in the same direction creating a bird's wing type of blade. The blade's inner surface area increases the wind capturing area and the outer surface reduces the drag as the blades are rotating.

The blades of the different stages of fan blades (114, 116, 118, and 120) may also be designed with springs and shafts. Each fan blade, such as blade 404, is able to pivot on a rod or support 406 that may be next to the shaft 408. A spring 402 or other resistance producing device may bias the fan blade 404 in a first position or resting position. The spring 402 may be formed so that a blade 404 opens or move as the wind speed increases. For example, the blade may move from an eighty-five degree wind angle to a five degree wind angle as the speed of wind increases from one mile an hour to two-hundred and fifty miles per hour.

The blades of the wind jet turbine may generate power with an electric generator. The power coils and magnets may be wired differently within the same housing to generate either Alternating Current (AC) on Direct Current (DC) sources. The electric generator is designed to reduce losses and increase efficiency. The power generation in the generator section is based on a new principal of generating power in a rotating machine utilizing the principals of magnets in combination with duration and electric cancellation called Magnetic Width Modulation (MWM). The MWM principle may be applied to motors, generation or any machine where magnetic variation is needed.

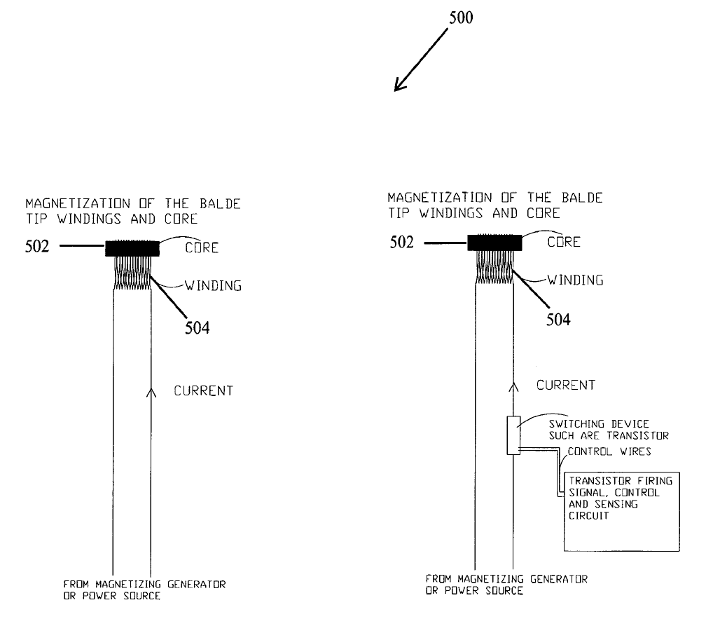

Turning to FIG. 5, a perspective and diagrammatical view 500 of an embodiment of an induced magnet 502 at the end of each rotating blade of wind jet turbine 100 in accordance with an example implementation is shown. The wind jet turbine 100 may use main permanent magnets and/or induced magnets 502 located at the tip of the blades. The main power coils 106, FIG. 1 may be located on or in the housing 102 of the wind jet turbine. At the center of the assembly and attached to the blades (for example, see 124, FIG. 1), a small magnetizing generator or power source may induce and magnetize the cores that become the induced magnets 502 and windings 504 located on the tip of each blade. The induction or magnetizing of the core 502 may occur periodically and relative to the rotational speed of the blades.

The magnetizing generator 124 or power source may be located in the center of the wind jet turbine 100 and increases or decreases the current delivered to the induced magnet coil 504 at the tips of the blades relative to the rotational speed of the fan blades (and magnetizing generator 124). The increasing or decreasing of the magnetic strength which will increase or decrease the power output of the wind jet turbine is thus modified with the rotation of the fan blades. In other words, the increase and decrease of current may be relative to the wind speed or velocity and/or the rotation or rounds per minute (RPM) of the turning blades.

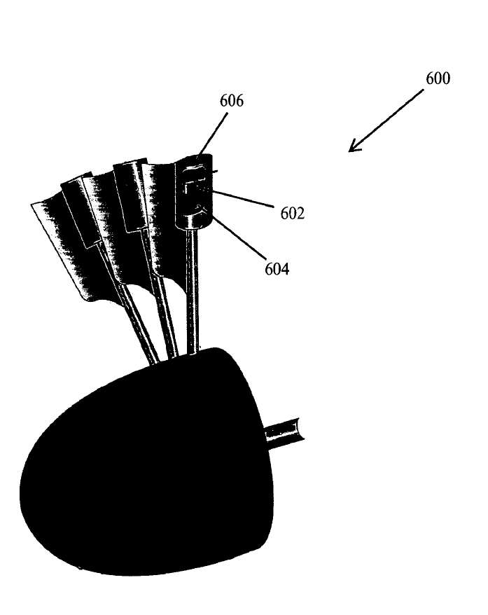

Turning to FIG. 6, a perspective and diagrammatical view 600 of an embodiment of the permanent magnet 602 and spring 604 at the end of each rotating blade 606 of wind jet turbine 100 in accordance with an example implementation is shown. With the permanent magnet 602 rotating within the windings (see 106, FIG. 1); the flux strength variation may be mechanically controlled by increasing or decreasing the distance of the permanent magnets from the main power coils (sometimes referred to as windings). The permanent magnet 602 may be equipped with a variable or biasing mechanism, such as spring 604, located at the blade end 606 that moves in response to the centrifugal force of the blade and adjusts and/or varies the distance of the permanent magnet 602 relative to the main power coils 106 of FIG. 1. This will maximize the power output of the wind jet turbine 100 at any speed by synchronizing the magnetization strength introduced to the main power winding coils 106 with the wind speed. This variable magnetization approach enables the wind jet turbine 100 to harness the smallest amount of wind more efficiently than traditional wind turbines.

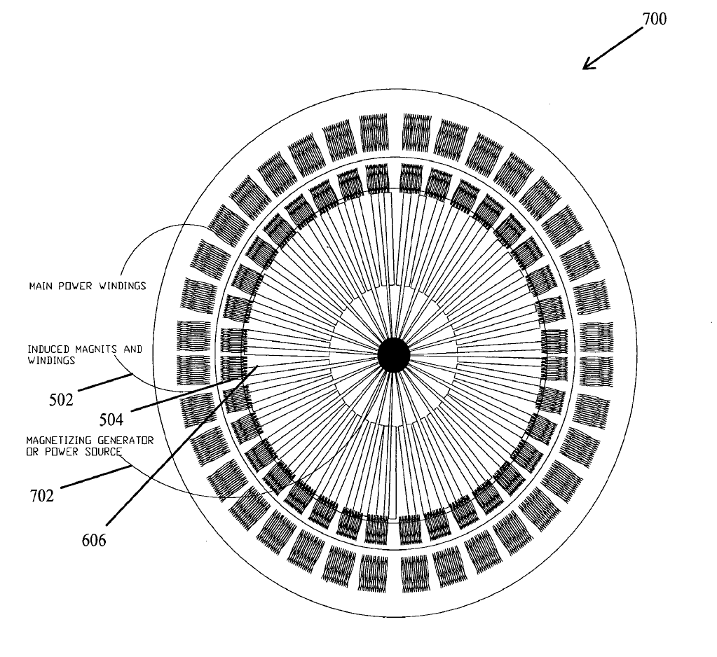

In FIG. 7, a diagrammatical representation 700 of the main generator power core and windings of wind jet turbine 100 in accordance with an example implementation is shown. Induced magnets (502 core and coil 504) may be located on the tips of the blades 606. The induced magnets may be powered by a small magnetizing generator 702 placed in the center of the housing 102 (i.e., at a hub) on a main shaft. The power from the magnetizing generator 702 may be varied in response to the wind speed and will magnetize the windings on the tips of the blades relative to that response.

The magnetizing generator 702 may be a permanent magnet generator that has power output directed though a variety of silicon controlled rectifiers (SCR) and/or transistors controlled by a control circuit. The control circuit may turn off and on the SCRs and/or transistors and vary the firing timing in order to produce the desired magnitude and proper frequency sequence. By controlling the magnetic field passing through the stator winding, full control of the generator output is achieved. This full control allows for the maximizing of the power output of the wind jet turbine 100 at any speed by synchronizing the wind speed with the transistor firing timing. This control approach results in the magnetization amplitude maximizing the power output of the wind jet turbine 100.

The power coils, permanent magnets and/or induced magnets may be wired differently within the same housing to produce Alternating Current (AC) on Direct Current (DC) sources. The AC power may be delivered to the load or a transformer and produce the desired output for any grid, commercial, vehicle, sea vehicles, and any other applications.

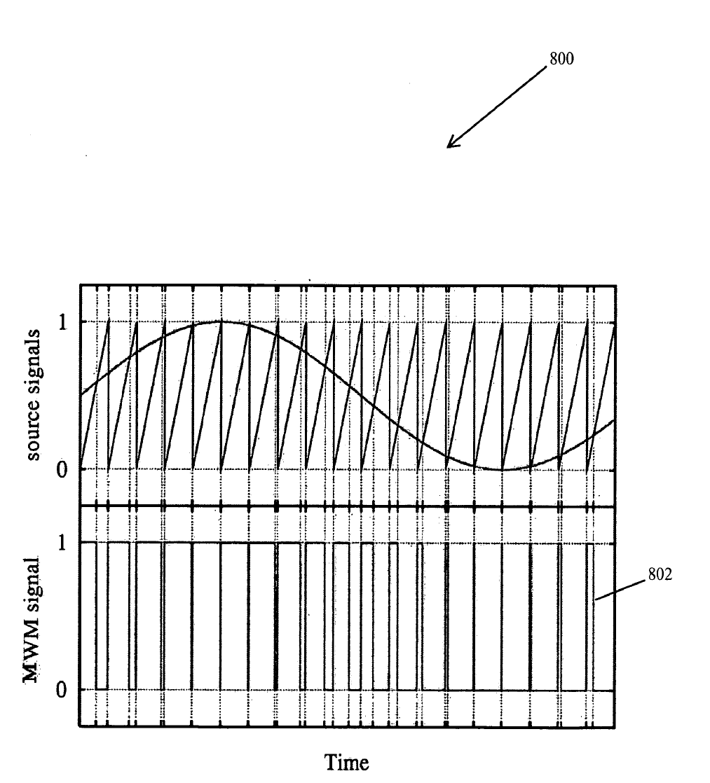

Turning to FIG. 8, a diagrammatical view representation 800 of the wave form of a variable width magnet signal 802 is shown. The power coils, induced magnets and/or permanent magnets are implemented as a variable magnetic wave generator. The variable magnetic wave generator approach may be referred to as Magnetic Width Modulation (MWM). The electronic control system will monitor the generator output waveform 800 (for example, voltage, current, and zero crossing of the waveforms) and the magnet or induced magnet position in relation to the winding position. The electronic control will initial a signal source relative to the waveform and induced magnet position. The signal source is directed through an electronic signal isolator and firing circuit to turn on and off power transistors in a variable format to correct and keep the output waveform 802 potential and frequency at the desired level. The firing circuit is connected to the transistors that pass through a current in variable form (in relation to the source signal) to the windings in the induced magnets.

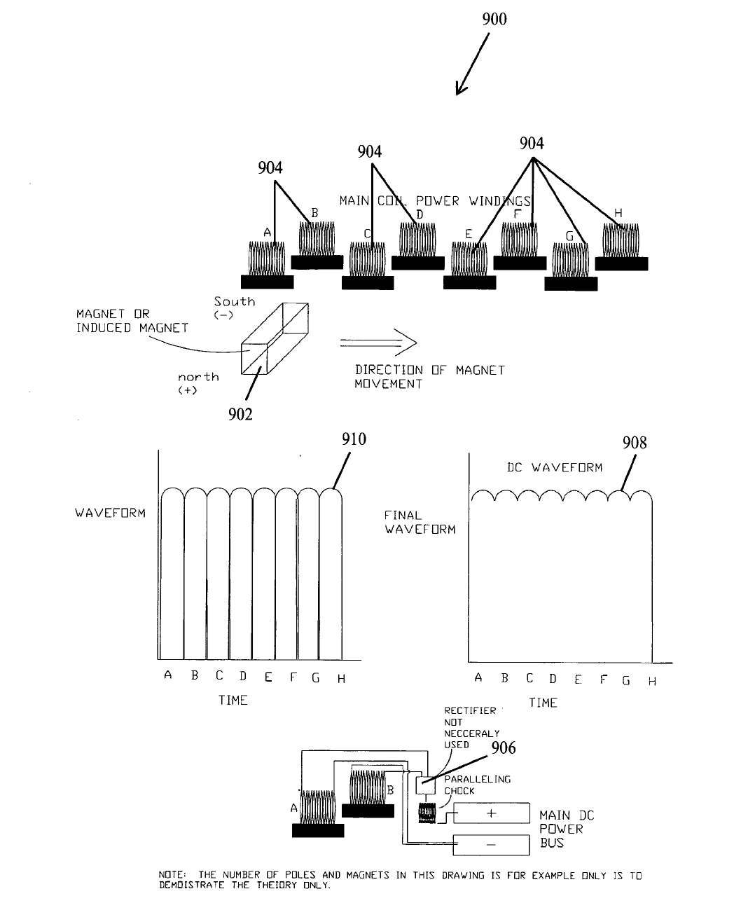

In FIG. 9, a diagrammatical view representation 900 of the main generator power core and windings example of generating DC power with the wind jet turbine 100 in accordance with an example implementation is shown. The DC power may be delivered to the load or to summing bus bars then to DC-to-DC and/or DC-to-AC converters (i.e., a static converter, an inverter or electro-mechanical converter such as a motor generator) and produce the desired AC or DC output for any grid, commercial, vehicle, sea vehicles, or other application.

The production of DC power may be achieved by utilizing the magnets, such as magnet 902, in the blade tips crossing thought multiple power coils 904. The power coils 904 may be arranged and/or positioned to accept the negative and positive flux of the magnets and redirect the current of both fluxes to produce one current in one direction. This may be achieved by utilizing the power coils connection arrangements and/or by using rectifiers 906, such as diodes/SCRs, thus creating a positive DC waveform 908 from an initial waveform 910 for both positive and negative magnetic fluxes.

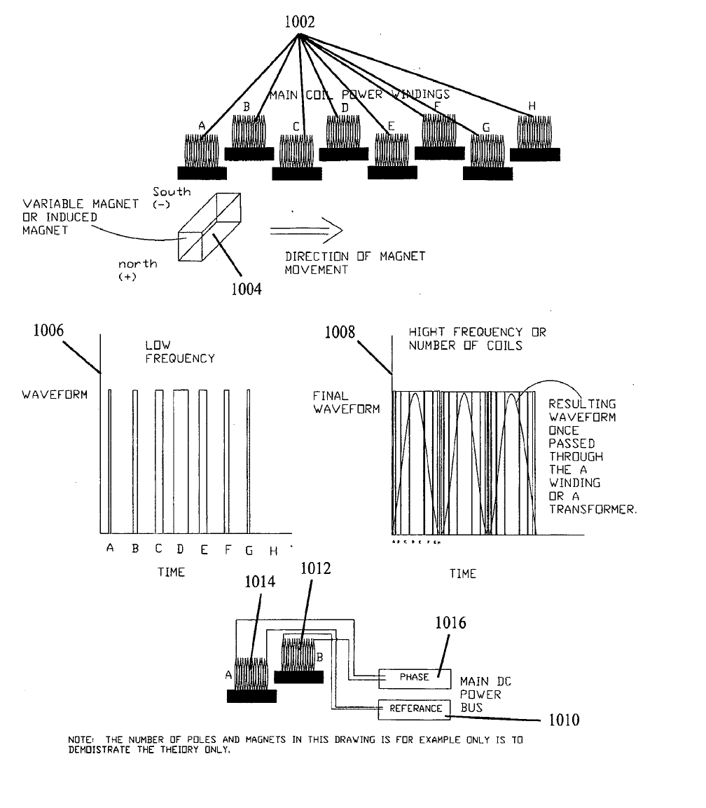

Turning to FIG. 10, a diagrammatical view representation 1000 of the main generator power core and windings 1002 of an example wind jet turbine 100 generating AC power directly in accordance with an example implementation is shown. The production of AC power directly by the wind jet turbine 100 may be accomplished by utilizing an approach of varying the time duration of the magnetic field and associated magnetic flux introduced to the power coils 1002. This may be achieved by utilizing either of permanent magnet tips or induced magnet tips 1004. The varying through time of the magnetic flux's amplitude and frequency results in MWM and may have a waveform as shown in graph 1006. The changes in the magnetic flux introduced to the magnetic winding 1002 on the tip of the blades can be controlled and varied electronically or mechanically to generate a waveform as shown in graph 1008.

The mechanical control of the MWM is preferably designed with variable/different widths of flux-transmitting permanent, induced magnets, and receiving power coils and cores. The electrical control of the MWM is preferably applied to the permanent magnet tips design and is preferably designed with an electronic controlled circuit that produces on/off signals for the transistors similar to Pulse Width Modulation in a predetermined order that control the current flow to the induced magnets. This control of the transistors produces a controlled flux amplitude and duration at the tip of the blades in respect to time and rotation. The reference signal 1010 senses the waveform amplitude, frequency and zero crossing and then sends a reference signal back to the controller. The controller utilizes the reference signal to correct the firing signal going to the transistors, which in turn is fed to the windings 1012 and 1014 as a phase power 1016.

Thus, the MWM approach is able to produce a clean AC waveform. For example, the magnetic field duration changes through time in an increasing then decreasing manner as shown in graph 1008. The magnetic flux changes its duration in the flux exchange area, such as permanent magnet 1004, to main power coils or induced magnets to the main power coils. For induced magnets, the flux duration change may be accomplished by either increasing or decreasing the power coil and core size/width of the flux exchange area, and/or by the magnetization duration of the induced magnets on the tips of the blades.

For permanent magnets, the flux duration change may be achieved by either increasing or decreasing the power coil and core size/width of the flux exchange area and/or by the reducing or increasing the permanent magnets size and/or surface area on the tips of the blades. The flux changing through time generates an increasing and decreasing waveform width that when summed and combined at higher frequency will results in a combined AC power waveform.

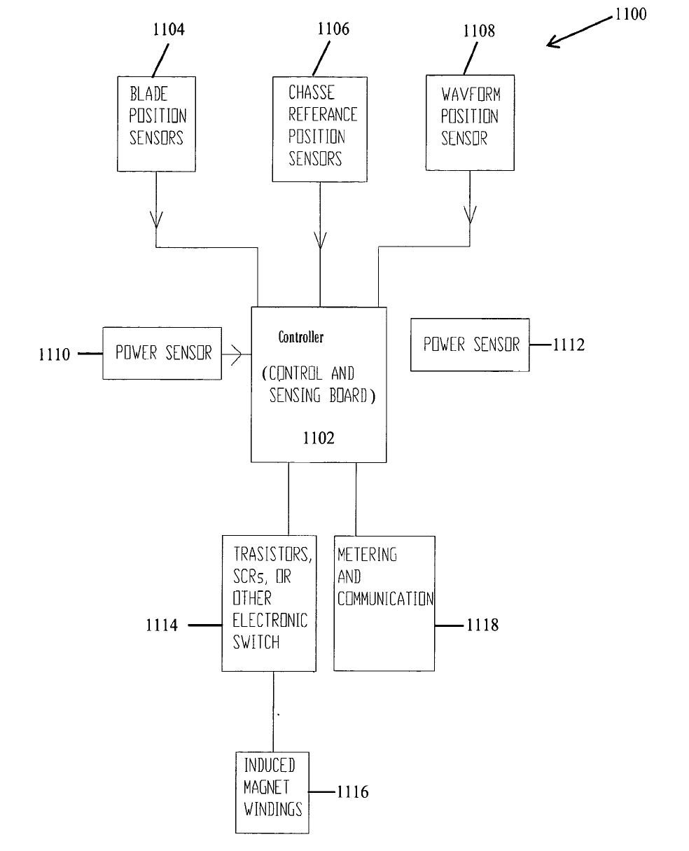

In FIG. 11, a block diagram of the control circuit 1100 for a sensing, reporting and control circuit of the transistor firing for the induced magnets coils in accordance with an example implementation of the present invention is shown. A controller 1102 is in communication with blade position sensors 1104, chasse reference position sensors 1106, wave position sensors 1108, and power sensors 1110 and 1112. The controller 1102 monitors the sensors and generates control signals to the transistors, SRCs, or other electrical switches that control the output power 1114. The types of controls will vary depending on the type of current being output by the wind jet turbine 100. The transistors, SCRs, or other electrical switches 1114 may also be in communication with induced magnet windings 1116 in order to adjust the flux of the induced magnet. The controller 1102 may also be coupled to reporting devices and ports, such as metering and communication block 1118. The metering and communication block 1118 may contain internet connections or modems for communicating with the controller and accessing data along with storage, such as disk drives and memory for storing operating data and metrics in a database for later processing and reporting. The controller may be implemented as a single control device, such as an embedded controller or digital signal processor, a microprocessor, or a control and sensing board made up of one or more of embedded controllers, digital signal processors, microprocessor, display, and logic devices (discrete and analog).

The blade position sensors 1104 may sense the blade/winding position in relation to the induced magnet or magnet position and sends the signal to the controller 1102. The waveform position sensor 1108 may sense the current and voltage as it crosses the zero position (the zero position is when the voltage is zero and/or the current is zero) and transmits the signal to the controller 1102. The power sensors 1110 may monitor the output voltage and current levels and send the signal to the controller 1102. The metering board and communication block 1118 translates, transmits and displays all power information and electrical operation of the wind jet turbine 100. The controller 1102 may translate and otherwise process all incoming signals from the blade sensor, wave sensor, and power sensor boards. The controller 1102 may then send the appropriate signals (on and off signals) to the transistor and/or SCR electronic switch 1114 that controls the amount of current, frequency and voltage of the induced magnets in relation to the position of the magnets and waveforms.

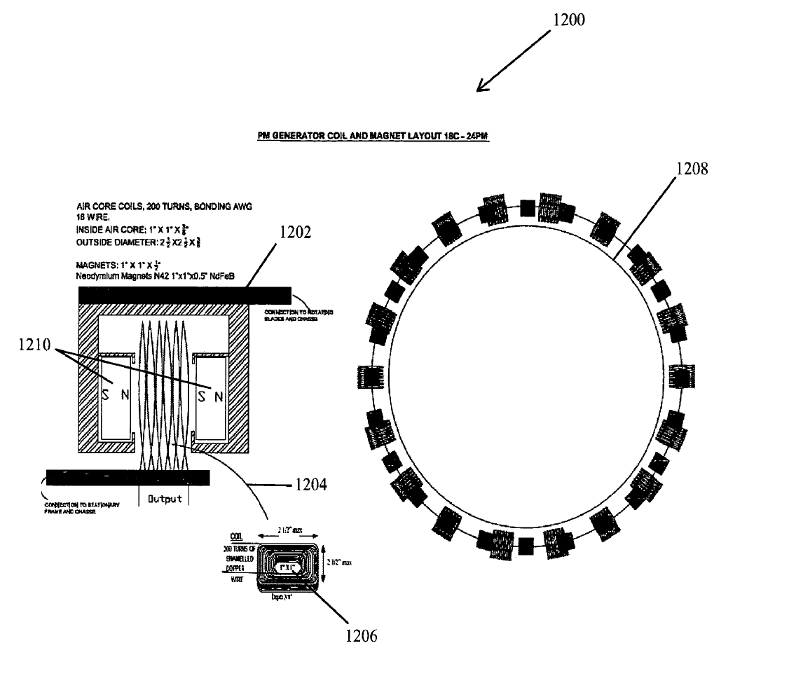

Turning to FIG. 12, a drawing of a U-shaped rotor 1202 and the stator coils 1204 together in one assembly in accordance with an example implementation of the present invention is shown. The physical arrangement of the generator, the number of turns and coil sizes varies depends on the kW size of the wind turbine generator 100. The stator section of the permanent magnet and the MWM pulse generator may be designed with coils that are coreless 1206. The coils may be placed in a circular frame 1208 that is fixed to the main assembly. The rotor of the generator may have permanent magnets or induced magnets 1210 that are formed or set in a U-shaped assembly facing each other with the positive side of one permanent magnet or induced magnet facing the negative side of the other permanent magnets or induced magnets. The U-shaped rotor assembly allows the rotor to embody the stator section where the coils will be passing through the U-shaped rotor and crossing the magnetic field at an optimum angle.

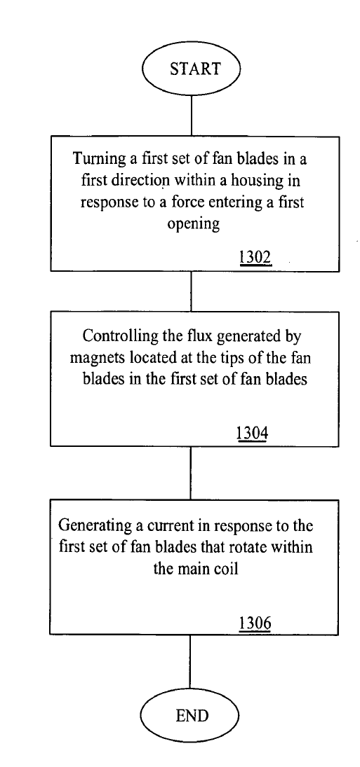

In FIG. 13, a flow diagram 1300 of the generation of current by the wind jet turbine of FIG. 1 in accordance with an example implementation is shown. A housing that has at least one set of blades 114, FIG. 1, turns in a first direction in response to a force, such as wind or water passing over the set of blades 1302. The flux generated by the magnets located at the tips of the fan blades in the first set of fan blades is controlled or altered 1304 by altering the position of the magnets or if induced magnets are employed, altering the induced current running through the coils of the induced magnets. The altering of the induced current and the direction of the winding of the coils of the induction magnets may be controlled in a way to generate alternating current, such as with MWM. As the flux generated by the magnets located at the tips of the fan blades pass through the main coil, a current may be generated 1306.

The magnets are described as being located at the tips of the fan blade. The term “at the tips” may mean at the very end of the fan blade, in a side of the fan blade at a region close to the end of the fan blade, or attached to the blade at a region close to the end of the fan blade.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A wind jet turbine, comprising:
a housing;
an at least one set of fan blades located within the housing and secured to a hub; and
a plurality of magnets located at tips of at least a portion of the set of fan blades, where a flux generated by the plurality of magnets is altered in relation to at least one coil in response to rotation of the at least one set of fan blades and the flux passing through the at least one coil results in generation of electrical current.

2. The wind jet turbine of claim 1, where the housing has a first housing portion and a second housing portion, where the at least one set of fan blades resides in the first housing portion and a second set of fan blades resides in a second housing portion.

3. The wind jet turbine of claim 2, where the first housing portion and the second housing portion define a space that allows entry of fluid from outside the wind jet turbine to enter the second housing portion.

4. The wind jet turbine of claim 3, where a third set of fan blades is located in the first housing portion.

5. The wind jet turbine of claim 4, where the third set of fan blades rotate in an opposite direction from the at least one set of fan blades.

6. The wind jet turbine of claim 3, where a fourth set of fan blades is located in the second housing portion.

8. The wind jet turbine of claim 6, where the fourth set of fan blades rotate in an opposite direction from the second set of fan blades.

9. The wind jet turbine of claim 1, where a first set of fan blades make up the at least one set of fan blades and each blade of the first set has a first blade portion that covers less than an area defined between the hub and the tip.

10. The wind jet turbine of claim 9, where the area covered is 50% or less.

11. The wind jet turbine of claim 10, where the second set of blades that make up the second set of fan blades has fan blades that cover a portion of the area not covered by the first blade portion.

12. The wind jet turbine of claim 9, where each of the fan blades in the first set of fan blades moves in response to the rotation of the fan blades.

13. The wind jet turbine of claim 12, where the fan blades are in a first position when at rest.

14. The wind jet turbine of claim 13, where a spring biases the fan blades in the first position.

15. The wind jet turbine of claim 1, where the plurality of magnets is a plurality of permanent magnets.

16. The wind jet turbine of claim 15, where each of the permanent magnets is biased in a first position when the fan blades are at rest.

17. The wind jet turbine of claim 16, where a spring biases each of the permanent magnets in the first position.

18. The wind jet turbine of claim 15, where the permanent magnets change position with rotation of the at least one set of fan blades.

19. The wind jet turbine of claim 1, where the plurality of magnets is a plurality of induced magnets.

20. The wind jet turbine of claim 19, where a variable current is used by the induced magnets and is associated with wind speed.

21. The wind jet turbine of claim 20, where the variable current is generated by a generator.

22. The wind jet turbine of claim 20, where the generator is powered by the wind jet turbine.

23. The wind jet turbine of claim 1, were the generation of an electrical current is generation of direct current (DC).

24. The wind jet turbine of claim 1, where the generation of electrical current is controlled by a controller to generate an alternating current (AC) current directly.

25. The wind jet turbine of claim 24, where the controller controls turning on and off current to the induced magnets.

26. The wind jet turbine of claim 1, where the housing has a decreasing diameter.

27. The wind jet turbine of claim 1, where the housing has a shape that results in a vacuum at one end of the housing.

28. A method of generating current with a wind jet turbine, comprising,
turning a first set of fan blades in a first direction within a housing in response to a fluid entering a first opening;
controlling flux generated by magnets located at the tips of the fan blades in the first set of fan blades; and
generating a current in response to the first set of fan blades that rotate within a main coil.

29. The method of claim 28, where controlling the flux generated by the magnets further includes,
changing the position of the magnets in response to the rotation of the first set of fan blades and where the magnets are permanent magnets.

30. The method of claim 29, where the changing the position of the magnets further includes,
extending a spring that is coupled between each of the permanent magnets and the fan blades in the first set of fan blades in response to the rotation.

31. The method of claim 28, where controlling the flux includes:
inducing an induction current in a coil at the tips of the fan blades in the first set of fan blades; and
generating the flux in response to the induction current.

32. The method of claim 31, where controlling the flux further includes altering the induction current in response to the rotation of the first set of fan blades.

33. The method of claim 32, where the altering of the induction current is associated with the current generated being alternating current.

33. The method of claim 28, where the fluid is air.

34. The method of claim 28, where the fluid is water.
